(19) United States
(12) Patent Application Publication
(10) Pub. No.: US 2013/0298552 A1
(43) Pub. Date: Nov. 14, 2013

(54) SYSTEMS AND METHODS FOR SERIES-SEQUENTIAL TURBOCHARGING

(71) Applicant: Scuderi Group, Inc., West Springfield, MA (US)

(72) Inventors: David Branyon, San Antonio, TX (US); Dean Jacob Simpson, San Antonio, TX (US)

(21) Appl. No.: 13/874,632

(22) Filed: May 1, 2013

Related U.S. Application Data
(60) Provisional application No. 61/644,813, filed on May 9, 2012.

(51) Int. Cl. F02B 37/00

(52) U.S. Cl. CPC F02B 37/00
USPC 60/605.2; 60/273

(57) ABSTRACT

Series-sequential turbocharging systems and related methods are disclosed herein for boosting the intake pressure of an internal combustion engine, such as a split-cycle engine that operates in accordance with a Miller cycle. In some embodiments, a multi-stage turbocharging system is used in which a small flow capacity turbocharger with an associated turbine bypass valve is incorporated in series with a larger turbocharger and an aftercooler. At low engine speeds, the bypass valve is closed and the small flow capacity turbocharger performs the bulk of the compression work. At high engine speeds, the bypass valve is opened and the larger turbocharger performs the bulk of the compression work. The bypass valve can be modulated when the engine is operated at transitional speeds. Using this series-sequential turbocharging system, the boost and flow range required for optimal efficiency and performance can be met across the engine's speed range.

### CROSS-REFERENCE TO RELATED APPLICATIONS

This application claims the benefit of priority of U.S. Provisional Patent Application No. 61/644,813, filed on May 9, 2012, the entire contents of which are hereby incorporated by reference.

### FIELD

The present invention relates to systems and methods for series-sequential turbocharging. In some embodiments, the present invention relates to series-sequential turbocharging systems and related methods that involve a split-cycle internal combustion engine.

### BACKGROUND

### Engine Technology

For purposes of clarity, the term “conventional engine” as used in the present application refers to an internal combustion engine wherein all four strokes of the well-known Otto cycle (the intake, compression, expansion and exhaust strokes) are contained in each piston/cylinder combination of the engine. Each stroke requires one half revolution of the crankshaft (180 degrees crank angle (“CA”)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine generally comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween.

A split-cycle air hybrid engine combines a split-cycle engine with an air reservoir (also commonly referred to as an air tank) and various controls. This combination enables the engine to store energy in the form of compressed air in the air reservoir. The compressed air in the air reservoir is later used in the expansion cylinder to power the crankshaft. In general, a split-cycle air hybrid engine as referred to herein comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft;

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween; and

an air reservoir operatively connected to the crossover passage and selectively operable to store compressed air from the compression cylinder and to deliver compressed air to the expansion cylinder.

FIG. 1 illustrates one exemplary embodiment of a prior art split-cycle air hybrid engine. The split-cycle engine 100 replaces two adjacent cylinders of a conventional engine with a combination of one compression cylinder 102 and one expansion cylinder 104. The compression cylinder 102 and the expansion cylinder 104 are formed in an engine block in which a crankshaft 106 is rotatably mounted. Upper ends of the cylinders 102, 104 are closed by a cylinder head 130. The crankshaft 106 includes axially displaced and angularly offset first and second crank throws 126, 128, having a phase angle therebetween. The first crank throw 126 is pivotally joined by a first connecting rod 138 to a compression piston 110, and the second crank throw 128 is pivotally joined by a second connecting rod 140 to an expansion piston 120 to reciprocate the pistons 110, 120 in their respective cylinders 102, 104 in a timed relation determined by the angular offset of the crank throws and the geometric relationships of the cylinders, crank, and pistons. Alternative mechanisms for relating the motion and timing of the pistons can be utilized if desired. The rotational direction of the crankshaft and the relative motions of the pistons near their bottom dead center (BDC) positions are indicated by the arrows associated in the drawings with their corresponding components.

The four strokes of the Otto cycle are thus “split” over the two cylinders 102 and 104 such that the compression cylinder 102 contains the intake and compression strokes and the expansion cylinder 104 contains the expansion and exhaust strokes. The Otto cycle is therefore completed in these two cylinders 102, 104 once per crankshaft 106 revolution (360 degrees CA).

During the intake stroke, intake air is drawn into the compression cylinder 102 through an inwardly-opening (opening inwardly into the cylinder and toward the piston) poppet intake valve 108 that controls fluid communication between an intake port 109 and the compression cylinder 102. During the compression stroke, the compression piston 110 pressurizes the air charge and drives the air charge through a crossover passage 112, which acts as the intake passage for the expansion cylinder 104. The engine 100 can have one or more crossover passages 112.

The volumetric (or geometric) compression ratio of the compression cylinder 102 of the split-cycle engine 100 (and for split-cycle engines in general) is herein referred to as the “compression ratio” of the split-cycle engine. The volumetric (or geometric) compression ratio of the expansion cylinder 104 of the engine 100 (and for split-cycle engines in general) is herein referred to as the “expansion ratio” of the split-cycle engine. The volumetric compression ratio of a cylinder is well known in the art as the ratio of the enclosed (or trapped) volume in the cylinder (including all recesses) when a piston reciprocating therein is at its BDC position to the enclosed volume (i.e., clearance volume) in the cylinder when said piston is at its top dead center (TDC) position. Specifically for split-cycle engines as defined herein, the compression ratio of a compression cylinder is determined when the XovrC valve is closed. Also specifically for split-cycle engines as defined herein, the expansion ratio of an expansion cylinder is determined when the XovrE valve is closed.

Due to very high volumetric compression ratios (e.g., 20 to 1, 30 to 1, 40 to 1, or greater) within the compression cylinder 102, an outwardly-opening (opening outwardly away from the cylinder and piston) poppet crossover compression (XovrC) valve 114 at the inlet of the crossover passage 112 is used to control flow from the compression cylinder 102 into the crossover passage 112. Due to very high volumetric compression ratios (e.g., 20 to 1, 30 to 1, 40 to 1, or greater) within the expansion cylinder 104, an outwardly-opening poppet crossover expansion (XovrE) valve 116 at the outlet of the crossover passage 112 controls flow from the crossover passage 112 into the expansion cylinder 104. The actuation rates and phasing of the XovrC and XovrE valves 114, 116 are timed to maintain pressure in the crossover passage 112 at a high minimum pressure (typically 20 bar or higher at full load) during all four strokes of the Otto cycle.

At least one fuel injector 118 injects fuel into the pressurized air at the exit end of the crossover passage 112 in coordination with the XovrE valve 116 opening. Alternatively, or in addition, fuel can be injected directly into the expansion cylinder 104. The fuel-air charge fully enters the expansion cylinder 104 shortly after the expansion piston 120 reaches its TDC position. As the piston 120 begins its descent from its TDC position, and while the XovrE valve 116 is still open, one or more spark plugs 122 are fired to initiate combustion (typically between 10 to 20 degrees CA after TDC of the expansion piston 120). Combustion can be initiated while the expansion piston is between 1 and 30 degrees CA past its TDC position. More preferably, combustion can be initiated while the expansion piston is between 5 and 25 degrees CA past its TDC position. Most preferably, combustion can be initiated while the expansion piston is between 10 and 20 degrees CA past its TDC position. Additionally, combustion can be initiated through other ignition devices and/or methods, such as with glow plugs, microwave ignition devices, or through compression ignition methods.

The XovrE valve 116 is then closed before the resulting combustion event enters the crossover passage 112. The combustion event drives the expansion piston 120 downward in a power stroke. Exhaust gases are pumped out of the expansion cylinder 104 through an inwardly-opening poppet exhaust valve 124 during the exhaust stroke. The exhaust valve 124 controls fluid communication between the expansion cylinder 104 and an exhaust port 125.

With the split-cycle engine concept, the geometric engine parameters (i.e., bore, stroke, connecting rod length, compression ratio, etc.) of the compression and expansion cylinders are generally independent from one another. For example, the crank throws 126, 128 for the compression cylinder 102 and expansion cylinder 104, respectively, have different radii and are phased apart from one another with TDC of the expansion piston 120 occurring prior to TDC of the compression piston 110. This independence enables the split-cycle engine to potentially achieve higher efficiency levels and greater torques than typical four-stroke engines.

The geometric independence of engine parameters in the split-cycle engine 100 is also one of the main reasons why pressure can be maintained in the crossover passage 112 as discussed earlier. Specifically, the expansion piston 120 reaches its TDC position prior to the compression piston 110 reaching its TDC position by a discrete phase angle (typically between 10 and 30 crank angle degrees). This phase angle, together with proper timing of the XovrC valve 114 and the XovrE valve 116, enables the split-cycle engine 100 to maintain pressure in the crossover passage 112 at a high minimum pressure (typically 20 bar absolute or higher during full load operation) during all four strokes of its pressure/volume cycle. That is, the split-cycle engine 100 is operable to time the XovrC valve 114 and the XovrE valve 116 such that the XovrC and XovrE valves 114, 116 are both open for a substantial period of time (or period of crankshaft rotation) during which the expansion piston 120 descends from its TDC position towards its BDC position and the compression piston 110 simultaneously ascends from its BDC position towards its TDC position. During the period of time (or crankshaft rotation) that the crossover valves 114, 116 are both open, a substantially equal mass of gas is transferred (1) from the compression cylinder 102 into the crossover passage 112 and (2) from the crossover passage 112 to the expansion cylinder 104. Accordingly, during this period, the pressure in the crossover passage is prevented from dropping below a predetermined minimum pressure (typically 20, 30, or 40 bar absolute during full load operation). Moreover, during a substantial portion of the intake and exhaust strokes (typically 90% of the entire intake and exhaust strokes or greater), the XovrC valve 114 and XovrE valve 116 are both closed to maintain the mass of trapped gas in the crossover passage 112 at a substantially constant level. As a result, the pressure in the crossover passage 112 is maintained at a predetermined minimum pressure during all four strokes of the engine's pressure/volume cycle.

For purposes herein, the method of opening the XovrC 114 and XovrE 116 valves while the expansion piston 120 is descending from TDC and the compression piston 110 is ascending toward TDC in order to simultaneously transfer a substantially equal mass of gas into and out of the crossover passage 112 is referred to as the “push-pull” method of gas transfer. It is the push-pull method that enables the pressure in the crossover passage 112 of the engine 100 to be maintained at typically 20 bar or higher during all four strokes of the engine's cycle when the engine is operating at full load.

The crossover valves 114, 116 are actuated by a valve train that includes one or more cams (not shown). In general, a cam-driven mechanism includes a camshaft mechanically linked to the crankshaft. One or more cams are mounted to the camshaft, each having a contoured surface that controls the valve lift profile of the valve event (i.e., the event that occurs during a valve actuation). The XovrC valve 114 and the XovrE valve 116 each can have its own respective cam and/or its own respective camshaft. As the XovrC and XovrE cams rotate, eccentric portions thereof impart motion to a rocker arm, which in turn imparts motion to the valve, thereby lifting (opening) the valve off of its valve seat. As the cam continues to rotate, the eccentric portion passes the rocker arm and the valve is allowed to close.

The split-cycle air hybrid engine 100 also includes an air reservoir (tank) 142, which is operatively connected to the crossover passage 112 by an air reservoir tank valve 152. Embodiments with two or more crossover passages 112 may include a tank valve 152 for each crossover passage 112 which connects to a common air reservoir 142, may include a single valve which connects all crossover passages 112 to a common air reservoir 142, or each crossover passage 112 may operatively connect to separate air reservoirs 142.

The tank valve 152 is typically disposed in an air tank port 154, which extends from the crossover passage 112 to the air tank 142. The air tank port 154 is divided into a first air tank port section 156 and a second air tank port section 158. The first air tank port section 156 connects the air tank valve 152 to the crossover passage 112, and the second air tank port section 158 connects the air tank valve 152 to the air tank 142. The volume of the first air tank port section 156 includes the volume of all additional recesses which connect the tank valve 152 to the crossover passage 112 when the tank valve 152 is closed. Preferably, the volume of the first air tank port section 156 is small relative to the second air tank port section 158. More preferably, the first air tank port section 156 is substantially non-existent, that is, the tank valve 152 is most preferably disposed such that it is flush against the outer wall of the crossover passage 112.

The tank valve 152 may be any suitable valve device or system. For example, the tank valve 152 may be an active valve which is activated by various valve actuation devices (e.g., pneumatic, hydraulic, cam, electric, or the like). Additionally, the tank valve 152 may comprise a tank valve system with two or more valves actuated with two or more actuation devices.

The air tank 142 is utilized to store energy in the form of compressed air and to later use that compressed air to power the crankshaft 106. This mechanical means for storing potential energy provides numerous potential advantages over the current state of the art. For instance, the split-cycle air hybrid engine 100 can potentially provide many advantages in fuel efficiency gains and NOx emissions reduction at relatively low manufacturing and waste disposal costs in relation to other technologies on the market, such as diesel engines and electric-hybrid systems.

The engine 100 typically runs in a normal operating or firing (NF) mode (also commonly called the engine firing (EF) mode) and one or more of four basic air hybrid modes. In the EF mode, the engine 100 functions normally as previously described in detail herein, operating without the use of the air tank 142. In the EF mode, the air tank valve 152 remains closed to isolate the air tank 142 from the basic split-cycle engine. In the four air hybrid modes, the engine 100 operates with the use of the air tank 142.

The four basic air hybrid modes include:

1) Air Expander (AE) mode, which includes using compressed air energy from the air tank 142 without combustion;

2) Air Compressor (AC) mode, which includes storing compressed air energy into the air tank 142 without combustion;

3) Air Expander and Firing (AEF) mode, which includes using compressed air energy from the air tank 142 with combustion; and

4) Firing and Charging (FC) mode, which includes storing compressed air energy into the air tank 142 with combustion.

Further details on split-cycle engines can be found in U.S. Pat. No. 6,543,225 entitled Split Four Stroke Cycle Internal Combustion Engine and issued on Apr. 8, 2003; and U.S. Pat. No. 6,952,923 entitled Split-Cycle Four-Stroke Engine and issued on Oct. 11, 2005, each of which is incorporated by reference herein in its entirety.

Further details on air hybrid engines are disclosed in U.S. Pat. No. 7,353,786 entitled Split-Cycle Air Hybrid Engine and issued on Apr. 8, 2008; U.S. Patent Application No. 61/365,343 entitled Split-Cycle Air Hybrid Engine and filed on Jul. 18, 2010; and U.S. Patent Application No. 61/313,831 entitled Split-Cycle Air Hybrid Engine and filed on Mar. 15, 2010, each of which is incorporated by reference herein in its entirety.

Miller Cycle

The split nature of split-cycle engines makes them uniquely suited for operation in accordance with a “Miller cycle.” A Miller cycle is one in which the amount of expansion that takes place during an engine cycle exceeds the amount of compression. Split-cycle engines can be easily configured to operate in a Miller cycle, for example by downsizing the compression cylinder(s) relative to the expansion cylinder(s). Less energy is required to compress the air in the compression cylinder in such configurations, leading to an increase in efficiency. The reduced compression cylinder size also reduces the knock tendency of the engine. The air and fuel flow through the engine, however, is controlled by the trapped mass in the compression cylinder, which is then forced through the rest of the engine. If the compression cylinder is downsized, power output from the engine is reduced given the same expansion cylinder displacement, even though efficiency increases. The intake air charge can be boosted (e.g., using a turbocharger or supercharger) to partially compensate for the reduced compression. In most cases, however, there is a tradeoff between the boost level that a turbocharger or supercharger is capable of providing and the flow range associated therewith. In particular, it is difficult to simultaneously obtain the optimal boost level and flow range. Accordingly, a need exists for improved Miller cycle engines and systems and methods relating thereto.

### SUMMARY

Series-sequential turbocharging systems and related methods are disclosed herein for boosting the intake pressure of an internal combustion engine, such as a split-cycle engine that operates in accordance with a Miller cycle. In some embodiments, a multi-stage turbocharging system is used in which a small flow capacity turbocharger with an associated turbine bypass valve is incorporated in series with a larger turbocharger and an aftercooler. At low engine speeds, the bypass valve is closed and the small flow capacity turbocharger performs the bulk of the compression work. At high engine speeds, the bypass valve is opened and the larger turbocharger performs the bulk of the compression work. The bypass valve can be modulated when the engine is operated at transitional speeds between the low engine speeds and high engine speeds. Using this series-sequential turbocharging system, the boost and flow range required for optimal efficiency and performance can be met across the engine's speed range.

In one aspect of at least one embodiment of the invention, a series-sequential turbocharging system is provided that includes a large turbocharger having a large compressor and a large turbine, a small turbocharger having a small compressor and a small turbine, the small turbocharger having a lower flow capacity than the large turbocharger, an aftercooler configured to remove heat from fluid passing therethrough, and a turbine bypass valve configured to selectively prevent fluid from flowing through a turbine bypass conduit. The large compressor is coupled to the small compressor such that fluid exiting the large compressor enters the small compressor. The small compressor is coupled to the aftercooler such that fluid exiting the small compressor enters the aftercooler. The aftercooler is coupled to an intake port of an engine such that fluid exiting the aftercooler enters the intake port. The small turbine and the turbine bypass valve are coupled to an exhaust port of the engine such that fluid exiting the exhaust port enters either the small turbine or the turbine bypass valve. The large turbine is coupled to the small turbine and the turbine bypass conduit such that fluid flowing through the small turbine and fluid flowing through the bypass conduit enter the large turbine. The turbine bypass valve is configured to prevent fluid from flowing through the turbine bypass conduit when the engine is operating below a first threshold speed. The turbine bypass valve is configured to allow fluid to flow through the turbine bypass conduit when the engine is operating above a second threshold speed.

Related aspects of at least one embodiment of the invention provide a system (e.g., as described above) that includes a compressor bypass valve configured to selectively prevent fluid from flowing around the small compressor through a compressor bypass conduit. The compressor bypass valve is configured to prevent fluid from flowing through the compressor bypass conduit when the engine is operating below the first threshold speed. The compressor bypass valve is configured to allow fluid to flow through the compressor bypass conduit when the engine is operating above the second threshold speed.

Related aspects of at least one embodiment of the invention provide a system (e.g., as described above) in which the engine is a split-cycle engine that operates using a Miller cycle.

Related aspects of at least one embodiment of the invention provide a system (e.g., as described above) in which the second threshold speed is greater than the first threshold speed.

Related aspects of at least one embodiment of the invention provide a system (e.g., as described above) in which the turbine bypass valve is modulated when the engine is operating between the first and second threshold speeds.

Related aspects of at least one embodiment of the invention provide a system (e.g., as described above) in which the first threshold speed is about 2000 rpm and the second threshold speed is about 3500 rpm.

In another aspect of at least one embodiment of the invention, a series-sequential turbocharging system is provided that includes a large turbocharger disposed in series with a small turbocharger, the small turbocharger having a lower flow capacity than the large turbocharger. The system also includes a bypass valve having a closed configuration in which the entire exhaust flow of an engine is routed through a turbine of the small turbocharger and an open configuration in which a portion of the exhaust flow is routed through the small turbocharger turbine and a portion of the exhaust flow is routed around the small turbocharger turbine. The bypass valve is placed in the closed configuration when the engine operates below a first threshold speed and is placed in the open configuration when the engine operates above a second threshold speed.

In another aspect of at least one embodiment of the invention, a method of operating a series-sequential turbocharging system that includes a small turbocharger and a large turbocharger having a greater flow capacity than the small turbocharger is provided. The method includes, when an engine to which the system is coupled is operating below a first threshold speed, routing the entire exhaust flow of the engine through a turbine of the small turbocharger such that the small turbocharger performs the majority of the work required to provide compressed intake air to the engine. The method also includes, when the engine is operating above a second threshold speed, routing a first portion of the exhaust flow through the small turbocharger turbine and routing a second portion of the exhaust flow through a bypass conduit such that the second portion does not flow through the small turbocharger turbine and such that the large turbocharger performs the majority of the work.

Related aspects of at least one embodiment of the invention provide a method (e.g., as described above) that includes cooling the intake air in an aftercooler after it is compressed by the small turbocharger.

Related aspects of at least one embodiment of the invention provide a method (e.g., as described above) in which the engine is a split-cycle engine that operates using a Miller cycle.

Related aspects of at least one embodiment of the invention provide a method (e.g., as described above) in which the second threshold speed is greater than the first threshold speed.

Related aspects of at least one embodiment of the invention provide a method (e.g., as described above) in which the first threshold speed is about 2000 rpm and the second threshold speed is about 3500 rpm.

Related aspects of at least one embodiment of the invention provide a method (e.g., as described above) that includes modulating a bypass valve such that the work is distributed between the large turbocharger and the small turbocharger when the engine is operating between the first and second threshold speeds.

Related aspects of at least one embodiment of the invention provide a method (e.g., as described above) in which the bypass valve can be closed to force the entire exhaust flow of the engine to flow through the small turbocharger turbine.

The present invention further provides devices, systems, and methods as claimed.

### BRIEF DESCRIPTION OF THE DRAWINGS

The invention will be more fully understood from the following detailed description taken in conjunction with the accompanying drawings, in which:

FIG. 1 is a schematic cross-sectional diagram of a prior art air hybrid split-cycle engine;

FIG. 2 is a schematic diagram of a series-sequential turbocharging system in a low-speed operating mode; and

FIG. 3 is a schematic diagram of the series-sequential turbocharging system of FIG. 2 in a high-speed operating mode.

### DETAILED DESCRIPTION

Series-sequential turbocharging systems and related methods are disclosed herein for boosting the intake pressure of an internal combustion engine, such as a split-cycle engine that operates in accordance with a Miller cycle. In some embodiments, a multi-stage turbocharging system is used in which a small flow capacity turbocharger with an associated turbine bypass valve is incorporated in series with a larger turbocharger and an aftercooler. At low engine speeds, the bypass valve is closed and the small flow capacity turbocharger performs the bulk of the compression work. At high engine speeds, the bypass valve is opened and the larger turbocharger performs the bulk of the compression work. The bypass valve can be modulated when the engine is operated at transitional speeds between the low engine speeds and high engine speeds. Using this series-sequential turbocharging system, the boost and flow range required for optimal efficiency and performance can be met across the engine's speed range.

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Although certain methods and devices are disclosed herein in the context of a split-cycle engine and/or an air hybrid engine, a person having ordinary skill in the art will appreciate that the methods and devices disclosed herein can be used in any of a variety of contexts, including, without limitation, non-hybrid engines, two-stroke and four-stroke engines, conventional engines, natural gas engines, diesel engines, etc.

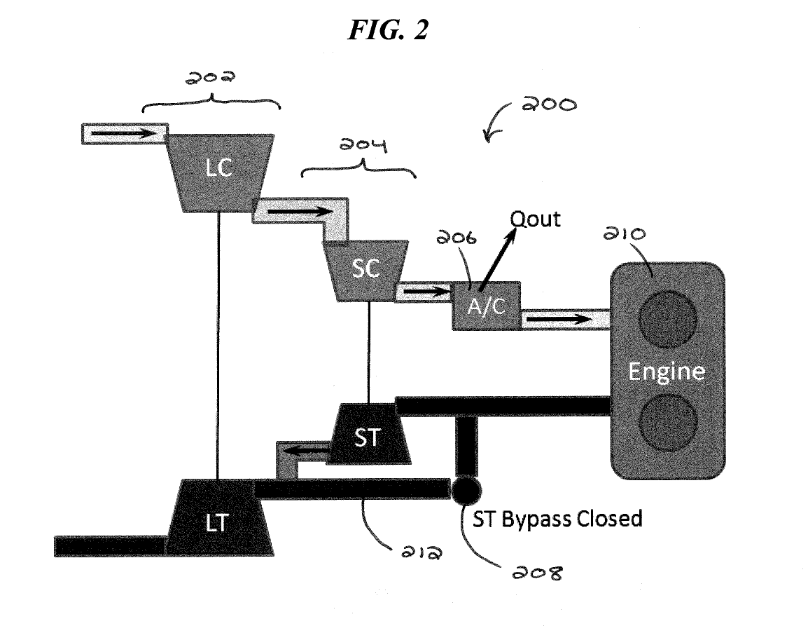

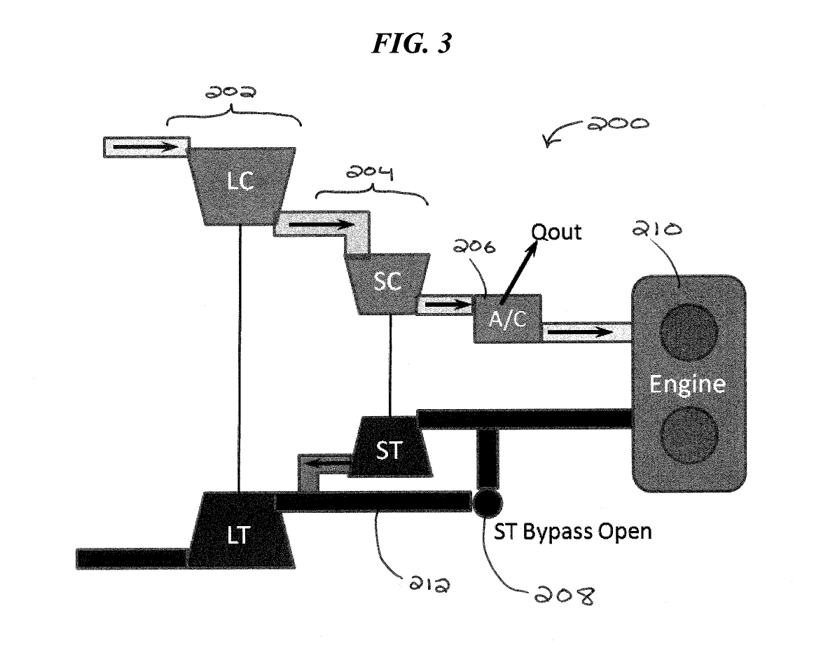

FIGS. 2-3 illustrate one exemplary embodiment of a series-sequential turbocharging system 200. As shown in FIG. 2, the system 200 generally includes a large turbocharger 202, a small turbocharger 204, an aftercooler 206, and a bypass valve 208. The large turbocharger 202 includes a large compressor LC and a large turbine LT. The small turbocharger 204 includes a small compressor SC and a small turbine ST. The system 200 is coupled to an engine 210, which can be a split-cycle engine, an air hybrid split-cycle engine, a split-cycle engine that employs a Miller cycle, an air hybrid split-cycle engine that employs a Miller cycle, a conventional engine, and so forth.

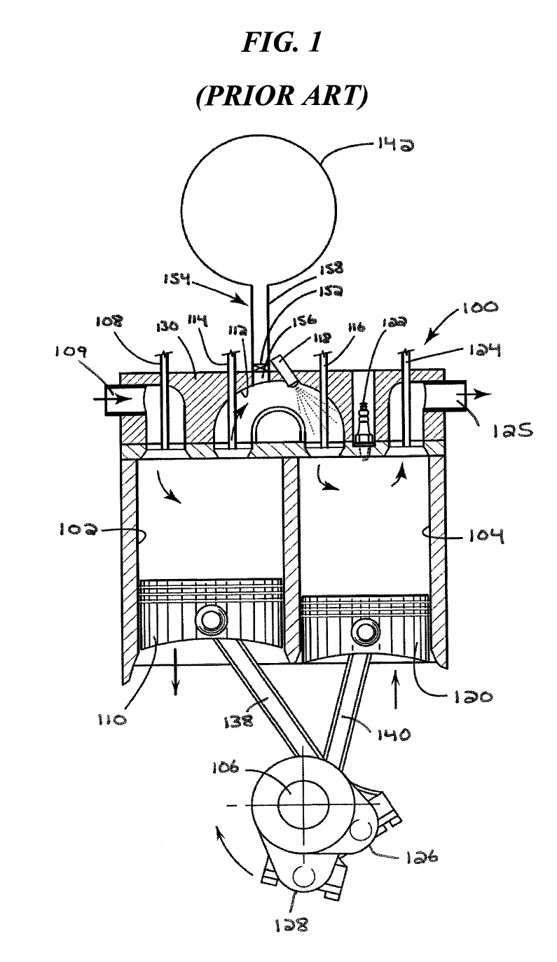

The large compressor LC is disposed upstream of the small compressor SC such that fluid exiting the large compressor LC enters the small compressor SC. The small compressor SC is in turn disposed upstream of the aftercooler 206 such that fluid exiting the small compressor SC enters the aftercooler 206. The outlet of the aftercooler 206 is coupled to and in fluid communication with the intake port of the engine 210. Thus, in the case of an air hybrid split-cycle engine of the type shown in FIG. 1, the outlet of the aftercooler 206 is coupled to the intake port 109 of the engine 100.

The exhaust port of the engine 210 is coupled to and in fluid communication with the small turbine ST and the bypass valve 208. Thus, in the case of an air hybrid split-cycle engine of the type shown in FIG. 1, the exhaust port 125 of the engine 100 is coupled to the small turbine ST and the bypass valve 208. The small turbine ST and the bypass valve 208 are disposed upstream of the large turbine LT such that fluid exiting the small turbine ST, or passing through the bypass valve 208, enters the inlet of the large turbine LT. The small turbocharger 204 is thus incorporated closest to the engine 210. The small turbocharger 204 has a lower flow capacity than the large turbocharger 202, and therefore is “smaller” than the large turbocharger 202.

The large turbine LT is configured to rotate as the exhaust exiting the engine 210 flows therethrough or thereacross. The large turbine LT is operatively coupled (e.g., via a common main shaft) to the large compressor LC. As the large turbine LT rotates, the large compressor LC also rotates, drawing in a charge of intake fluid (e.g., air) which is compressed and fed downstream.

Similarly, the small turbine ST is configured to rotate as the exhaust exiting the engine 210 flows therethrough or thereacross. The small turbine ST is operatively coupled (e.g., via a common main shaft) to the small compressor SC. As the small turbine ST rotates, the small compressor SC also rotates, drawing in a charge of intake fluid (e.g., air) which is compressed and fed downstream.

The aftercooler 206 restrains the intake temperature of the boosted air exiting the compressors LC, SC. This can be accomplished using any of a variety of systems or devices, such as air-to-air heat exchangers, air-to-water heat exchangers, and the like. The aftercooling of the boosted air can significantly increase the engine's inlet density, which provides higher compression cylinder trapped mass and increases the output capability of the engine 210. In addition, the aftercooling allows relatively high boost with limited increase in the knock tendency of the engine 210. In some embodiments, relatively high boost levels (e.g., about 2.5 bar absolute to about 2.9 bar absolute) are acceptable from an engine performance and knock perspective, depending on turbocharging efficiency and assuming that aftercooling is applied. Heat removed from the fluid flowing through the aftercooler is indicated as “Qout” in FIG. 2.

As explained above, the components of the system 200 are interconnected such that fluid compressed by the large compressor LC is fed into the inlet of the small compressor SC. Fluid exiting the small compressor SC is then fed through the aftercooler before entering the engine 210. The exhaust exiting the engine 210 is fed first into the small turbine ST and then through the large turbine LT. The bypass valve 208 is configured such that, when closed, substantially all of the exhaust exiting the engine 210 passes through the small turbine ST. When the bypass valve 208 is open, most of the exhaust exiting the engine 210 passes through a bypass conduit 212 and into the large turbine LT, instead of first passing through the small turbine ST. Even when the bypass valve 208 is open, however, a small portion of the exhaust still passes through the small turbine ST. The bypass valve 208 is functionally similar to a standard “waste gate” but has a higher flow capacity and may or may not be integral to the housing of the small turbine ST.

Although not shown in the drawings, a second bypass valve can be incorporated on the compressor side of the system 200 to bypass the small compressor SC. In particular, the compressor bypass valve can be disposed downstream of the large compressor LC and can be coupled to a bypass conduit coupled to the aftercooler 206 inlet. Thus, when the compressor bypass valve is open, some or most of the fluid exiting the large compressor LC can be routed directly into the aftercooler 206, without first passing through the small compressor SC.

In operation, the turbine bypass valve 208, and optionally a compressor bypass valve (not shown) can be opened, closed, or otherwise modulated depending on engine speed or other factors to provide the requisite boost and flow rate to the engine 210.

When the engine is operating at low speeds (e.g., less than or equal to about 2000 rpm), the system 200 is configured as shown in FIG. 2 such that the turbine bypass valve 208 is closed and the small turbine ST takes the bulk of the expansion ratio available from the engine 210 to ambient. In other words, substantially all of the exhaust charge exiting the engine 210 expands through the small turbine ST such that its pressure drops to near ambient pressure. The small compressor SC, which is sized for the low flow range of the engine, does the bulk of the compression work during this mode of operation. The large turbocharger 202 is still in the flow path and is spinning, but has low work values (and pressure ratios on both turbine LT and compressor LC). The large turbocharger 202 is “coasting” during this time.

When the engine is operating at high speeds (e.g., greater than or equal to about 3500 rpm), the system 200 is configured as shown in FIG. 3 such that the turbine bypass valve 208 is opened and the small turbocharger 204 is substantially disabled. The small turbine ST is still in the flow path and spinning, but the majority of the exhaust flow is bypassing it and the bulk of the expansion ratio is utilized by the large turbine LT. The large compressor LC therefore performs the bulk of the compression work with its outlet either flowing through, or optionally around, the small compressor SC. The small turbocharger 204 is “coasting” during this time.

When the engine is operating at intermediate speeds (e.g., greater than about 2000 rpm and less than about 3500 rpm), the bypass valve(s) can be modulated to achieve the best performance. In this way, the high flow characteristics of the large turbocharger 202 are available at high engine speeds and the low flow characteristics of the small turbocharger 204 are available at low engine speeds. The boost levels and flow needs of the engine across the engine's speed range can thus be met by the series-sequential turbocharging system 200.

In an exemplary embodiment, the engine 210 has a high-load speed range of approximately 1400 rpm to approximately 4000 rpm. Therefore, a turbocharging system is needed which is able to provide the desired boost levels (e.g., about 2.5 bar absolute to about 2.9 bar absolute) across a flow range of between about 2.5:1 and about 2.9:1 (the flow range can be determined by 4000 rpm/1400 rpm≈2.9, since at a given boost level, air flow rate is proportional to engine speed). Turbochargers designed for use with diesel engines are typically characterized by high pressure ratios (e.g., approximately 4.0:1 or higher), which would provide a suitable boost level in this embodiment. Their flow ranges, however, are typically lower than what is required for this embodiment (e.g., approximately 2.0:1). On the other hand, turbochargers designed for use with gasoline or spark-ignited (SI) engines generally have flow ranges broad enough for this embodiment, but can only provide pressure ratios that are lower than what is required for this embodiment (e.g., approximately 2.0:1).

Using the series-sequential turbocharging system 200 disclosed above, however, the desired pressure ratio and flow range can be obtained. In particular, an approximately 2.5:1-2.9:1 pressure ratio can be obtained while also having a flow range of approximately 2.5:1-2.9:1. In this embodiment, the bypass valve 208 can be closed during low-speed operation such that the small turbocharger 204 does the bulk of the work between about 1400 rpm and about 2000 rpm. The bypass valve 208 can be opened during high-speed operation such that the large turbocharger 202 does nearly all of the work between 3500 rpm and 4000 rpm.

For intermediate engine speeds (speeds between about 2000 rpm and about 3500 rpm in this embodiment), the bypass valve 208 can be modulated such that the compression work is divided between the large turbocharger 202 and the small turbocharger 204. While a 1500 rpm modulation range (2000 rpm to 3500 rpm) is discussed above, it will be appreciated that any of a variety of modulation ranges can be used, such as 100 rpm, 250 rpm, 500 rpm, or 1000 rpm.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A series-sequential turbocharging system, comprising:
a large turbocharger having a large compressor and a large turbine;
a small turbocharger having a small compressor and a small turbine, the small turbocharger having a lower flow capacity than the large turbocharger;
an aftercooler configured to remove heat from fluid passing therethrough; and
a turbine bypass valve configured to selectively prevent fluid from flowing through a turbine bypass conduit;
wherein:
the large compressor is coupled to the small compressor such that fluid exiting the large compressor enters the small compressor;
the small compressor is coupled to the aftercooler such that fluid exiting the small compressor enters the aftercooler;
the aftercooler is coupled to an intake port of an engine such that fluid exiting the aftercooler enters the intake port;
the small turbine and the turbine bypass valve are coupled to an exhaust port of the engine such that fluid exiting the exhaust port enters either the small turbine or the turbine bypass valve;
the large turbine is coupled to the small turbine and the turbine bypass conduit such that fluid flowing through the small turbine and fluid flowing through the bypass conduit enter the large turbine;
the turbine bypass valve is configured to prevent fluid from flowing through the turbine bypass conduit when the engine is operating below a first threshold speed; and
the turbine bypass valve is configured to allow fluid to flow through the turbine bypass conduit when the engine is operating above a second threshold speed.

2. The system of claim 1, further comprising a compressor bypass valve configured to selectively prevent fluid from flowing around the small compressor through a compressor bypass conduit, wherein:
the compressor bypass valve is configured to prevent fluid from flowing through the compressor bypass conduit when the engine is operating below the first threshold speed; and
the compressor bypass valve is configured to allow fluid to flow through the compressor bypass conduit when the engine is operating above the second threshold speed.

3. The system of claim 1, wherein the engine is a split-cycle engine that operates using a Miller cycle.

4. The system of claim 1, wherein the second threshold speed is greater than the first threshold speed.

5. The system of claim 1, wherein the turbine bypass valve is modulated when the engine is operating between the first and second threshold speeds.

6. The system of claim 1, wherein the first threshold speed is about 2000 rpm and the second threshold speed is about 3500 rpm.

7. A series-sequential turbocharging system, comprising:
a large turbocharger disposed in series with a small turbocharger, the small turbocharger having a lower flow capacity than the large turbocharger;
a bypass valve having a closed configuration in which the entire exhaust flow of an engine is routed through a turbine of the small turbocharger and an open configuration in which a portion of the exhaust flow is routed through the small turbocharger turbine and a portion of the exhaust flow is routed around the small turbocharger turbine;
wherein the bypass valve is placed in the closed configuration when the engine operates below a first threshold speed and is placed in the open configuration when the engine operates above a second threshold speed.

8. A method of operating a series-sequential turbocharging system that includes a small turbocharger and a large turbocharger having a greater flow capacity than the small turbocharger, the method comprising:
when an engine to which the system is coupled is operating below a first threshold speed, routing the entire exhaust flow of the engine through a turbine of the small turbocharger such that the small turbocharger performs the majority of the work required to provide compressed intake air to the engine; and
when the engine is operating above a second threshold speed, routing a first portion of the exhaust flow through the small turbocharger turbine and routing a second portion of the exhaust flow through a bypass conduit such that the second portion does not flow through the small turbocharger turbine and such that the large turbocharger performs the majority of the work.

9. The method of claim 8, further comprising cooling the intake air in an aftercooler after it is compressed by the small turbocharger.

10. The method of claim 8, wherein the engine is a split-cycle engine that operates using a Miller cycle.

11. The method of claim 8, wherein the second threshold speed is greater than the first threshold speed.

12. The method of claim 8, wherein the first threshold speed is about 2000 rpm and the second threshold speed is about 3500 rpm.

13. The method of claim 8, further comprising modulating a bypass valve such that the work is distributed between the large turbocharger and the small turbocharger when the engine is operating between the first and second threshold speeds.

14. The method of claim 13, wherein the bypass valve can be closed to force the entire exhaust flow of the engine to flow through the small turbocharger turbine.
